(19) United States
(12) Patent Application Publication
(10) Pub. No.: US 2009/0094068 A1
(43) Pub. Date: Apr. 9, 2009

(54) METHOD AND APPARATUS FOR CONSTRUCTING INSURANCE PRODUCTS

(76) Inventors: Herbert H. Wright, Vero Beach, FL (US); Stephen W. Waterbury, Bay Head, NJ (US); David Hunzlker, Bay Head, NJ (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/247,581

(22) Filed: Oct. 8, 2008

Related U.S. Application Data
(60) Provisional application No. 60/998,007, filed on Oct. 8, 2007.

(51) Int. Cl. G06Q 40/00

(52) U.S. Cl. 705/4

(57) ABSTRACT

Running the individual illustration systems provided by the insurance companies is very complicated and time consuming. It requires an intimate knowledge of each system. This invention allows an agent to bypass all of that. The agent does not have to be an expert. The system 122 as shown in FIG. 2B is easy to use and provides information in a matter of seconds. It can take from two to ten minutes to run individual illustration systems. In this invention, it is recognized that the financial data associated with a particular plan is substantially proportional to the benefit amount. The deviation between the data produced by using the factor and the data produced by running an illustration for a particular benefit is in the worst case less that 1.5%. The ability to produce insurance reports quickly is a significant benefit to an insurance marketer. As a result, an agent with minimal computer training is easily able to produce a very complex insurance benefit plan document.

### REFERENCE TO RELATED APPLICATION

This application claims priority to Provisional Application No. 60/998,007 filed on Oct. 8, 2007 the entire disclosure of which is hereby incorporated by reference.

### FIELD OF THE INVENTION

This invention relates to a system that creates a database for storing benefit illustrations; each illustration displays cash flow, and profit and loss. More particularly, the system multiplies all of the illustration by a factor which is defined as the requested benefit amount divided by the reference amount.

### BACKGROUND OF THE INVENTION

U.S. Patent Publication Number 20060241989/US-A1 “FINANCIAL PLANNING METHOD AND COMPUTER SYSTEM”, published on Nov. 26, 2006 describes a computer system, program, and method for assisting financial professionals in determining appropriate financial products. This invention relates to computer systems and computer-implemented methods for assisting financial professionals in marketing financial products. This invention also includes a series of tabs, which can be selected to access other tools and modules of the system. A computer system, program, and method for assisting financial professionals in determining appropriate financial products for clients. The system and method present a first set of questions to a client and receives a first set of answers, then the system presents subsequent sets of questions to the client which are customized based on the answers to the first and other previous sets of questions so that the client is not asked redundant, unnecessary, or inappropriate questions, and receives answers to the subsequent sets of questions, wherein the questions request (A) personal information comprising client and dependent names, ages, and martial status (B) financial information on one or more of savings accounts, investment accounts, insurance policies, retirement accounts, stock options, trusts, history of gifts to family members, loans, charitable contributions, charitable trusts, property, businesses, and income sources and (C) goal information comprising retirement age and income goals and estate related goals. Information regarding each financial product available for sale by the financial professional is stored along with a set of rules which can be applied to the answers to the questions. In this way, which if any of the available financial products are appropriate to the client's financial situation and goals is determined for the financial professional.

Publication No. 2007103107/WO-A2. The present invention provides a life insurance product known as longevity insurance. Longevity insurance mitigates longevity risk, the risk that an individual will outlive his or her assets. More specifically, the purchase of longevity insurance guarantees an individual a predetermined, periodic income payment for t he life of the purchaser. The guaranteed stream of monthly income commences at a later date, which may be utilized to supplement an existing income level or provide income in the event that the individual outlives his or her accumulated assets.

Publication No. 20070203756/US-A1. A method, system, and computer program product to create a quote for providing a benefit such as an employee benefit of a group health insurance policy or a retirement plan. Products that can be associated with the quote are automatically determined using at least one rule for associating products with quotes. A product can be associated with the quote if the product satisfies the rules. Rules can require another product to be included with the product in the quote, require a given value for an attribute of the product, or require a relationship between the values of attributes of different products. Rules can also be added to specify how data for the products are presented in a display via a user interface. A user can use a configuration user interface to set up rules.

Publication No. 20070156559/US-A1. The financial planning tool is software defining a data structure which generates a financial-estate plan using liquidity analysis of a comprehensive list of client assets (categories I-IV, personal, reserve capital, unprotected retirement, and protected retirement assets). The system obtains asset net equity before and after tax and calculates life annual income based on a financial formula with modifiable variables. Current estate tax values and liquidity at-death values for estate conditions (client and spousal death, spousal survival and client survival). Post-death annual income is calculated. Comparing unprotected and protected life annual income for asset categories I-III vs. IV with goals, identified surpluses and deficiencies result in transfer or liquidation-repurchase of assets between categories. Conventional life insurance is either purchased or cancelled or a daily rated, minimum at risk death premium life insurance product is purchased.

Publication No. 2007018486/WO-A1. Methods and system of providing benefit plan administration (14). A method of providing benefit plan administration to a first sponsor (16) having at least one participant (12) enrolled in a benefit plan can include electronically receiving benefit plan information from the first sponsor (12), electronically providing benefit plan information to the first sponsor (16), and electronically providing benefit plan information to the at least one participant (12).

### SUMMARY

An illustrated embodiment of this invention takes the form of a method for allowing a user to quickly retrieve an illustration from a web site. The illustration illustrates a benefit plan for an individual from an inception to a year in which a beneficiary reaches the end of its life. The illustration further illustrates cash flow data and profit and loss data as associated with the benefit plan. The method further creates an illustration data base for storing a plurality of benefit illustrations. Each benefit illustration stores males, females and an inception age, whereby each of the plurality of benefit illustrations includes the same reference benefit. The method disposes the illustration database on an internet web site. Next, the user is enabled to retrieve an illustration by entering an indication that the beneficiary is a male, an indication that the beneficiary is a female, an indication of the age of the beneficiary and an indication of a benefit amount. The next step allows the indication of the male, the indication of the female or the indication of the age to illustrate the corresponding benefit amount by multiplying all of the illustrations in the corresponding indication by a factor. The factor comprises the requested benefit amount divided by the reference benefit a deviation between the indications produced by using the factor and the indications produced by an illustration system for the particular benefit whose deviation is not greater than 1.5%.

### BRIEF DESCRIPTION OF THE DRAWINGS

The foregoing illustrative embodiment of this invention may be more readily understood by one skilled in the art with reference being made as to the following description, taken in conjunction with the accompanying drawings wherein like elements are designated by identical reference numbers throughout the server view, and in which:

FIGS. 1A and B are a first illustrative embodiment of a flow diagram for running a company's illustration system and converting the illustrations to a format that is compatible with the illustration systems.

FIGS. 2A and B are function block diagrams, wherein FIG. 2A represents the computer architecture of a web base server, an illustration server and a benefit database, and FIG. 2B is representative of the detailed structure of the functional block diagrams, and

FIGS. 3, 4A and 4B represents computer flow diagrams for implementing a program on the computer architecture as shown in FIGS. 2A and 2B.

### DETAILED DESCRIPTION OF A PREFERRED EMBODIMENT OF THE INVENTION

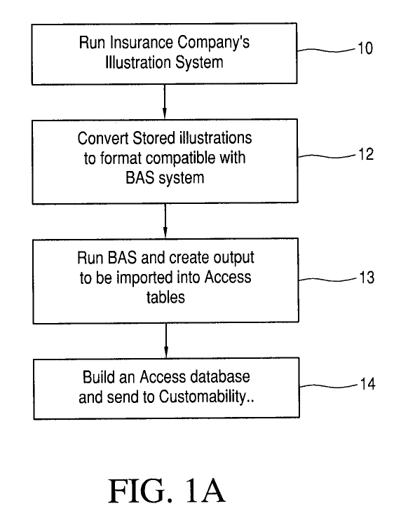

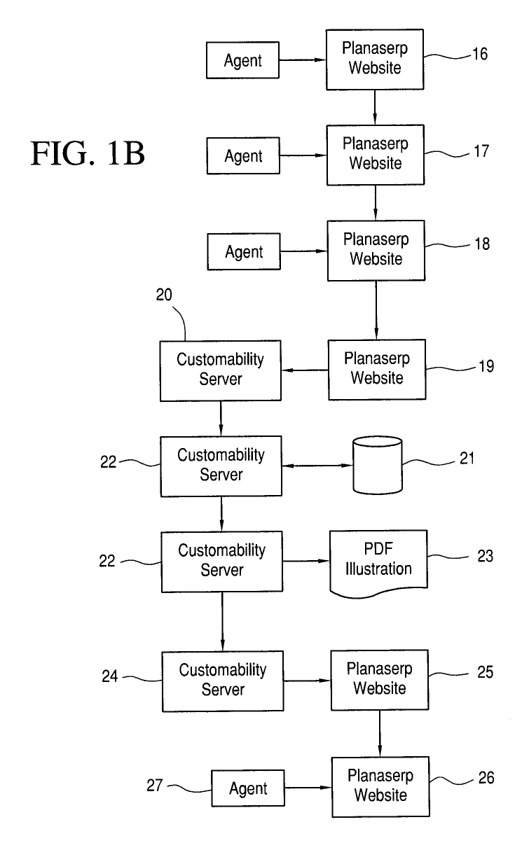

Referring now to the drawings and in particular to FIG. 1A, an illustration is created in step in 10 for each age from 30 to 60 for a male and a female. This is done for three illustration systems. There is a separate illustration for 10 year, 15 year, and lifetime benefits. It is assumed that the recipient retires at 65 and dies at 85. The benefit is $100,000. We also produce illustrations for an educational benefit plan that provides a four-year benefit to pay for a college education. We run this with one insurance illustration system for ages 30 to 45. For each age and gender there are 11 illustrations. The first has the benefit starting in 8 years, the second in 9 years and so forth. The illustrations are stored illustratively on disc in either text or Excel formats.

The stored illustrations are converted as shown in FIG. 12 to a format that is compatible with the input to the Benefit Service Company's Benefits Administration System (BAS). Next, the BAS system is run in step 13 for each illustration and an output is created to be imported into access tables. Then access macros are run in step 14 to import the illustrations into access tables. The tables are stored in an access database that is sent to customability.

Next in FIG. 1B, the agent logs on in step 16 to the Planaserp Website, before the agent in step 17 retrieves a screen to request a benefits illustration for an individual. Next in step 18, the agent enters parameters needed to retrieve a benefits illustration. The parameters are:

1) gender of recipient,

2) benefit amount,

3) recipients current agent, and

4) one of three possible insurance plans or an education plan. For each insurance plan there is a choice of a 10 year, 15 year, or lifetime benefit. Planaserp sends in step 19 parameters to customability server, before the customability server retrieves in step 20 data for the benefits illustration from an access database. It uses an access query to retrieve all the table records for a particular start age and gender. There will be a record for each year from the current year until age 85, which is the assumed age of death. Then in step 21, the customability produces a PDF formatted report that displays cash flow and profit and loss figures for the case. As shown in Appendix A, “Profit and Loss” is broken down into a number of data components. On the other hand as shown in Appendix B, cash flow is broken down in another set of data components. Since all the figures in the access database are based on a $100,000 benefit, customability multiplies each figure by a factor equal to the requested benefit divided by 100,000. The resulting figures are displayed in a PDF formatted report that illustrates the plan from the current age to age 85. The illustrations assume the participant retires at age 65. Customablity sends in step 22 the PDF report to the Planaserp server. Finally, the Planaserp in step 23 website displays the report and allows the agent to print it.

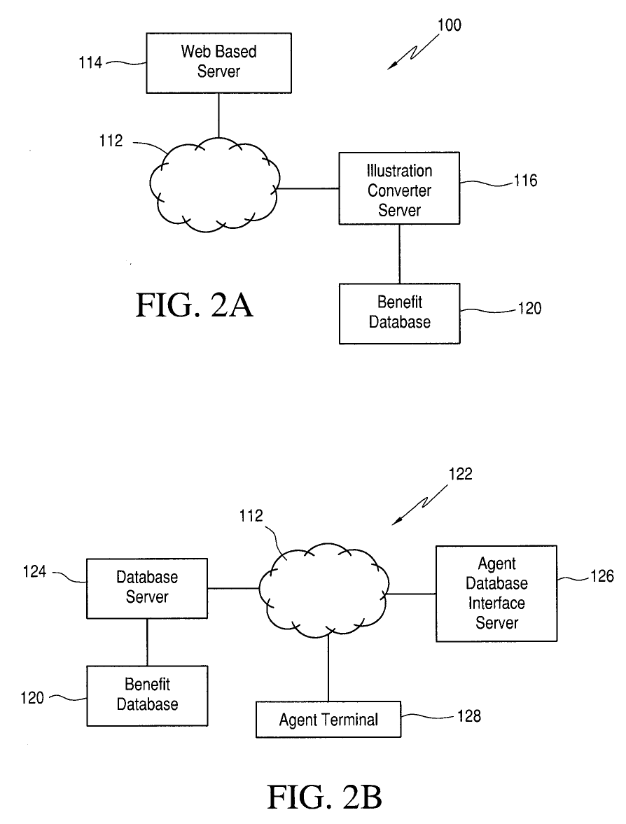

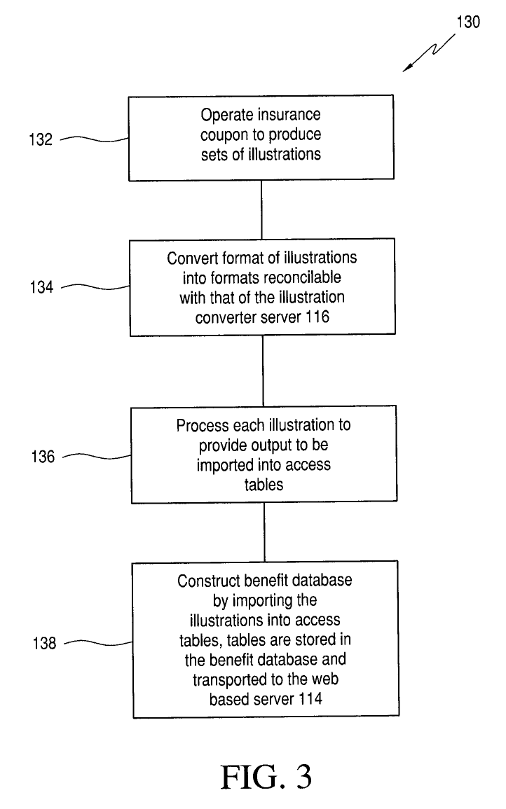

Referring now to FIG. 2A, there is shown an illustrative embodiment of this invention using an illustration construction system 100 to enable an agent to construct a plurality of illustrations that define insurance products. The illustration construction system 100 uses web based servers 114, provided by various insurance companies, to construct sets of illustrations for various benefit plans. The set of illustrations are transported over a data link 112, which in one illustrative embodiment of this invention may take the form of the Internet 112, to an illustration converter server 116, where the format of the illustrations is converted to match the format of the illustration construction system 100. After the format of the illustrations has been converted, that converted illustration data is stored in a benefit database 120. This database 120 is also the database 120 shown in FIG. 2A.

Referring now to FIGS. 2A and 2B, there is shown an insurance product construction system 122 using an agent terminal 128. The agent logs onto the agent interface server 126 and is provided with a set of web pages or screens that allows the agent to request a particular benefit plan for a beneficiary. The parameters associated with the benefit plans are sent by the agent interface server 126 to the database server 124. The database server 124 uses the parameters to retrieve data from the benefits database 120, creates an illustration and transmits the illustration to the agent interface server 124. In turn, the agent interface server 126 displays the illustrations on the agent terminal 128.

This invention is a tool, for example, that an agent may use to construct one or more reports that illustrate insurance data comprising premiums, cash values, death benefits, paid out cash, etc. Each report lists the insurance data by year from the current year until and including the year that the insured reaches the age of 85. This invention can implement a number of insurance products, all of which use life insurance to provide and finance an annual benefit to the person who is insured by the product. The product is usually owned by an employer who is using it to provide a benefit to a valued employee. The insurance products can provide for a number of retirement plans as well as plans that provide benefits to pay for a college or a private prep school education. As will be explained below, this invention constructs a set of illustrations that define the amount of the annual benefit that may be given to the prospective beneficiary and displays the illustrations over the Internet 112 in a PDF format that can be printed. The systems 100 and 112 can illustrate different products that can provide ten-year, fifteen-year, or lifetime retirement benefits. They may also define a four-year benefit that begins at the time the beneficiary's child enters college. These illustrations are constructed based on the assumption that the beneficiary retires at age 65 and dies at 85 if it is a retirement plan. In the case of the education plan, the benefit begins at an age designated by the employee that coincides with the year his or her child enters college. The age of death is still assumed to be 85.

Of particular significance is the fact that the financial data for each illustration is collected in advance and stored in a benefit database 120, which is accessed by the database server 124. This process is performed by the vendor who owns and manages the database server 124. There is financial data for each age, gender, and type of benefit plan. There is not a separate set of data for each possible benefit amount. Instead, each set of data is based on a single reference benefit amount. The process for using this reference amount to modify the financial data so that it illustrates the benefit requested by the user is explained below. The reference amount can be any amount. In an illustrative embodiment of this invention, the reference amount is $100,000 for retirement plans and $40,000 for education plans.

Referring now to FIGS. 2A and step132, there is shown a detailed diagram of the steps of the process that are generally identified by the blocks 114 and 116 as show in FIG. 2A. As shown in step 132, the data that is stored in the benefits database 120 is collected by running the construction systems provided by the insurance companies that are used by the inventor to provide the various benefit plans. In step 134, the data is converted to a format that will permit it to be input into and processed by a benefits administration system which may illustratively take the form of that system provided by the Benefit Service Company. As shown in step 136, each illustration is processed to be imported into tables of the benefits database 120. This stored data comprises the product premiums, the cash value of the insurance products, the death benefits, the withdrawals from the policy to pay the premiums, etc. In step 138, the benefits database 120 is transmitted to the vendor who owns and runs the database server 126.

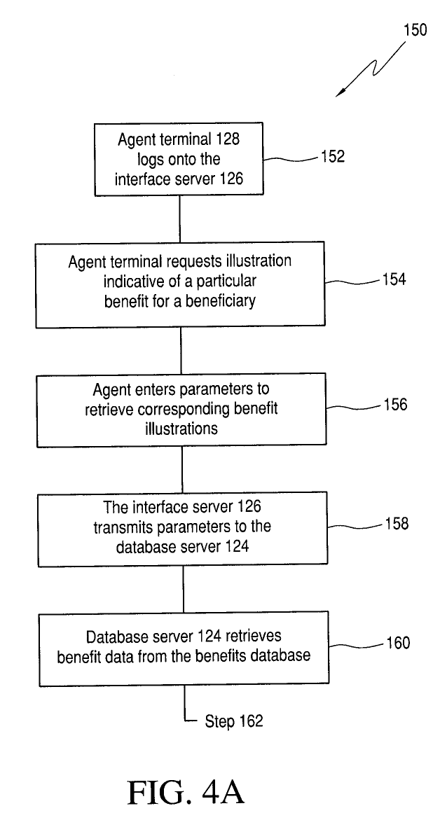

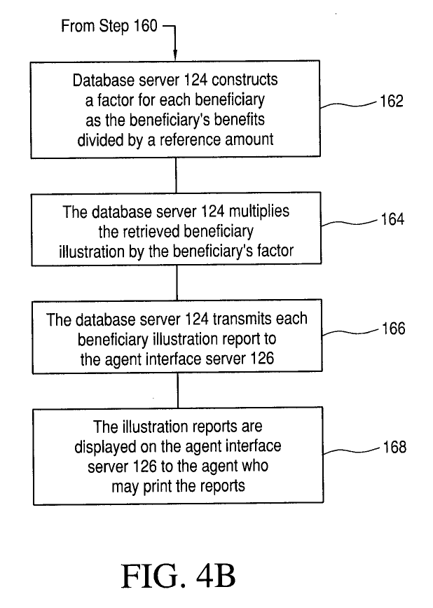

As shown in FIGS. 2B and 4A, the agent terminal 128 gains access in step 152 to the agent interface server 126, which displays a screen that allows an agent to choose in step 154 a benefit amount and a particular benefit plan. To that end, the agent enters in step 156 a particular set of parameters that define the benefits illustration for a particular insurance product. In step 158, the parameters are transmitted by the agent interface server 126 to the database server 124. The following parameters are used with the insurance products: 1) gender of the prospective beneficiary, 2) the monetary amount of the benefit, and 3) the current age of the prospective beneficiary. Other sets of insurance products may be produced for life insurance and retirement insurance products. Each of these products may pay out the insurance benefits over various lengths of time, e.g., 10 years, 15 years or a lifetime benefit. In the education product as described above, a parameter defines the year in which the pay out of the benefit starts. In step 60, the database server 24 retrieves the benefit data from the benefits database 120.

As shown in FIGS. 2B and 4B, the database server 124 in step 162 is programmed to select data from the benefits database 120 by using the parameters input by the agent. As disclosed above, all of the insurance data for a chosen product is based on a reference monetary amount, e.g., $100,000. To that end, the programmed database server 124 constructs a factor that will enable the server 24 to quickly adjust or customize the amount of the insurance benefit requested by the agent. In particular, the factor is calculated as the agent-requested benefit amount divided by the reference amount, e.g., $100,000. This factor is then used to adjust or customize the related insurance data amounts that have been retrieved from the database 120 for the benefit requested by the agent. In an illustrative example of this invention, an agent enters the requested insurance benefit in the amount of $50,000. In step 164, the database server 124 is programmed to customize the factor by dividing the requested insurance benefit $100,000, by the reference benefit. In this case, the database system server 124 multiplies the retrieved beneficiary illustration by the beneficiary's factor, i.e., the amount would be 0.5 or ½. In turn, the factor of 0.5 is multiplied by each of the financial data that is related to this insurance product. In step 166, the database server 124 transmits each beneficiary illustration report to the agent interface server 126. Finally in step 168, the agent interface server 126 then displays the calculated illustration to the agent, who may print it out

What is claimed is:

1. A method for allowing a user to quickly retrieve from a web site an illustration that illustrates a benefit plan for an individual from an inception to the year in which a beneficiary reaches the end of its life, the illustration illustrates cash flow data and profit and loss data as associated with the benefit plan, the method comprises steps of:
A. creating an illustration data base for storing a plurality of benefit illustrations, each benefit illustration stores males, females and an inception age, each of the plurality of benefit illustrations includes the same reference benefit;
B. disposing the Illustration Database on an internet web site.
C. enabling the user to retrieve an illustration by entering an indication that the beneficiary is a male, an indication that the beneficiary is a female, an indication of the age of the beneficiary and an indication of a benefit amount;
D. allowing the indication of the male, the indication of the female or the indication of the age to illustrate the corresponding benefit amount by multiplying all of the indications in the corresponding indication by a factor which is the requested benefit amount divided by the reference benefit; and
E. whereby a deviation between the indications produced by using the factor and the indications produced by an illustration system for the particular benefit is not greater than 1.5%.

2. A method for allowing a user to quickly and easily retrieve from a Web Site a report that illustrates a benefit plan for an individual from the plan inception to the year in which the beneficiary reaches the age of 85. The report illustrates the cash flow and profit and loss figures (including FASB87 accruals) associated with the plan. The method comprises steps of:
A. creating a database of benefit illustrations for males and females with an illustration for each inception age and with the same benefit (“reference benefit”) for each illustration. The illustrations are created by using the benefit illustration tools provided by various insurance companies and processing the output through a propriatory “Benefit Administration System” designed and administered by Planserp LLC.
B. storing the Illustration Database on an internet web site.
C. enabling the user to retrieve an illustration by entering gender, age and benefit amount.
D. allowing the stored data for a particular age and gender to illustrate any benefit amount by multiplying all the figures in corresponding data by a factor which is the requested benefit amount divided by the “reference benefit”. The deviation between the data produced by using the factor and the data produced by running an insurance company's illustration system for the particular benefit is in the worst case less than 1.5%., and
E. enabling the user to bypass having to run complicated insurance company illustration systems in order to retrieve a benefit illustration and eliminating the need for the user to be an expert in running various illustration systems.

3. A method of constructing a plurality of illustrations that define corresponding insurance products, said method comprising the steps of:
A. enabling an insurance agent to construct a set of illustrations that allows the insurance agent to select a particular benefit plan for a particular beneficiary;
B. storing insurance data in at least one of the plurality of illustrations;
C. constructing each of the plurality of illustrations to store insurance data periodically;
D. constructing each of the plurality of illustrations the amount of the periodic benefit that may be given to a prospective beneficiary;
E. collecting financial data for each illustration in advance (of what?) and stored;
F. establishing the financial value of the insurance data based on a single reference benefit amount;
G. enabling the insurance agent to select a set of parameters that define a benefit amount and a particular benefit plan for a particular insurance product;
H. using the parameters inputted by the insurance agent to select insurance data;
I. selecting the insurance data for a selected product and determining the insurance data as based on a reference monetary amount;
J. calculating a factor as the agent selected benefit amount divided by the reference amount to thereby adjust the related insurance data amount;
K. multiplying the factor by each of the financial date that is related to this insurance product, whereby the deviation between the data produced by using the factor and the data product by constructing a selected benefit does not exceed 1.5%.

4. A method for facilitating the speed at which an insurance agent may quickly select and construct at least one insurance product for a prospective beneficiary of the one insurance product, said method comprising the steps of:
A) constructing the one insurance product of the prospective beneficiary in accordance with a set of parameters that reflect the nature of the prospective beneficiary and the nature of the insurance product that the beneficiary has selected to purchase;
B) constructing a plurality of sets of insurance products that define the amount of the beneficiary income that may be given to the one set of insurance products;
C) each insurance product of the plurality of sets includes a same reference amount of the beneficiary;
D. creating a factor as the agent selected benefit amount divided by the reference amount; and
E) using the factor to enable the insurance agent to customize the factor by dividing the factor by the set of parameters.

5. The method of facilitating as claimed in claim 4, wherein said method further constructs the set of parameter comprises age and sex, and the nature of the insurance products comprising insurance, retirement in come insurance and educational insurance.

6. The method of facilitating as claimed in claim 4, wherein said method constructs a first set of insurance products that define the amount of the beneficiary income that may be given to the prospective beneficiary.

7. The method of facilitating as claimed in claim 6, wherein said method constructs a second set of insurance products that provide benefit coverage for 20 years and a male/female indication.

8. The method of facilitating as claimed in claim 7, wherein said method constructs a third set of insurance products that extends coverage for the like time of the beneficiary and a mail/female indication.

9. The method of facilitating as claimed in claim 4, wherein all of the selected insurance product is calculated as the agent-requested benefit amount divided by the reference.

10. The method of facilitating as claimed in claim 9, wherein the factor has customized the factor by dividing the requested insurance benefit by the reference benefit.

11. The method of facilitating as claimed in claim 10, where the retrieved beneficiary illustration by the beneficiary's factor.

12. The method of facilitating as claimed in claim 11, wherein the beneficiary adjusts the reference of the amount of the benefit by the user of the factor.

13. The method of facilitating as claimed in claim 12, wherein the beneficiary issues educational beneficiaries for a selected range of time.
